(19) United States
(12) Patent Application Publication
(10) Pub. No.: US 2026/0195199 A1
(43) Pub. Date: Jul. 9, 2026

(54) METHOD, DEVICE, AND COMPUTER PROGRAM PRODUCT FOR DATA SYNCHRONIZATION

(71) Applicant: DELL PRODUCTS L.P., ROUND ROCK, TX (US)

(72) Inventors: Ran LIU, Beijing (CN); Tao CHEN, Beijing (CN); Wei LU, Beijing (CN)

(21) Appl. No.: 19/057,637

(22) Filed: Feb. 19, 2025

(30) Foreign Application Priority Data
Jan. 8, 2025 (CN) 202510032864.X

(51) Int. Cl. G06F 9/52; G06F 9/30; G06F 13/42

(52) U.S. Cl. CPC G06F 9/52; G06F 9/3009; G06F 13/42

(57) ABSTRACT

A method includes setting, in response to a state variable being in a first state, a timeout period for an IO thread to acquire a read lock, the state variable being used for indicating an execution state of a control flow associated with data synchronization, and the first state indicating that the control flow is executing the data synchronization. The method further includes setting the state variable to a second state in response to not acquiring the read lock within the timeout period. In addition, the method further includes executing the data synchronization by utilizing the IO thread. Therefore, according to the embodiments of the present disclosure, by managing a state variable, an IO thread attempts to acquire a lock only when a control flow performs data synchronization, thereby reducing the lock usage frequency and synchronization overhead.

### TECHNICAL FIELD

Embodiments of the present disclosure relate to the field of computers, and more particularly, to a method, an apparatus, a device, and a computer program product for data synchronization.

### BACKGROUND

In the digital age, data synchronization and back-up have become an indispensable part of daily operations of enterprises and individuals. As the amount of information surges, the risk of data loss, damage, or failure to recover in a timely manner increases. Therefore, ensuring efficient synchronization, real-time updates, and safe storage of data across a plurality of platforms becomes particularly important.

As a result, data protection products become increasingly important. Enterprises and individuals are facing the challenge of storing, managing, and protecting massive data at increasing risks of data loss, damage, or leakage. With the increase of network attacks, system crashes, and other threats, a data protection product has become an indispensable core tool in all walks of life, thereby ensuring the safe operation of information systems and stable development of business.

### SUMMARY OF THE INVENTION

The embodiments of the present disclosure provide a method, a device, and a computer program product for data synchronization.

According to one aspect of the present disclosure, a method for data synchronization is provided. The method includes setting, in response to a state variable being in a first state, a timeout period for an input/output (IO) thread to acquire a read lock, the state variable being used for indicating an execution state of a control flow associated with data synchronization, and the first state indicating that the control flow is executing the data synchronization. The method further includes setting the state variable to a second state in response to not acquiring the read lock within the timeout period, the second state indicating that the control flow has timed out. In addition, the method further includes executing the data synchronization by utilizing the IO thread.

According to another aspect of the present disclosure, an electronic device is provided. The device includes a processing unit and a memory, where the memory is coupled to the processing unit and stores instructions. The instructions, when executed by the processing unit, perform the following actions: setting, in response to a state variable being in a first state, a timeout period for an input/output (IO) thread to acquire a read lock, the state variable being used for indicating an execution state of a control flow associated with data synchronization, and the first state indicating that the control flow is executing the data synchronization; setting the state variable to a second state in response to not acquiring the read lock within the timeout period, the second state indicating that the control flow has timed out; and executing the data synchronization by utilizing the IO thread.

According to still another aspect of the present disclosure, a computer program product is provided. The computer program product is tangibly stored on a non-transitory computer-readable medium and includes computer-executable instructions. The computer-executable instructions, when executed, cause a computer to perform the method or process according to the embodiments of the present disclosure.

The Summary of the Invention part is provided to introduce a selection of concepts in a simplified manner and will be further described in the following detailed description. The Summary of the Invention part is neither intended to identify key features or main features of the present disclosure, nor intended to limit the scope of the embodiments of the present disclosure.

### BRIEF DESCRIPTION OF THE DRAWINGS

By describing the example embodiments of the present disclosure in more detail with reference to the accompanying drawings, the above and other objectives, features, and advantages of the present disclosure will become more apparent. In the example embodiments of the present disclosure, the same reference numerals generally represent the same elements.

FIG. 1 is a schematic diagram of an example environment in which a device and/or a method according to an embodiment of the present disclosure can be implemented;

FIG. 2 is a flow chart of a method for data synchronization according to an embodiment of the present disclosure;

FIG. 3A is a schematic diagram of a data structure according to an embodiment of the present disclosure;

FIG. 3B is a schematic diagram of a data synchronization process according to an embodiment of the present disclosure;

FIG. 4 is a schematic diagram of a scenario of data synchronization according to an embodiment of the present disclosure;

FIG. 5 is a schematic diagram of another scenario of data synchronization according to an embodiment of the present disclosure; and

FIG. 6 is a schematic block diagram of a device that can be configured to implement an embodiment of the present disclosure.

In various accompanying drawings, identical or corresponding reference numerals represent identical or corresponding parts.

### DETAILED DESCRIPTION

Preferred embodiments of the present disclosure will be described in further detail below with reference to the accompanying drawings. While some specific embodiments of the present disclosure are shown in the accompanying drawings, it should be understood that the present disclosure may be implemented in various forms, and should not be limited to the embodiments set forth herein. Rather, these embodiments are provided such that the present disclosure is more thorough and complete, and the scope of the present disclosure can be fully conveyed to those skilled in the art.

The term “include” and variants thereof used herein indicate open-ended inclusion, that is, “including but not limited to.” Unless specifically stated, the term “or” means “and/or.” The term “based on” means “based at least in part on.” The terms “an example embodiment” and “an embodiment” indicate “at least one example embodiment.” The term “another embodiment” indicates “at least one additional embodiment.” The terms “first,” “second,” and the like may refer to different or identical objects, unless otherwise specifically indicated.

As mentioned earlier, data protection products play an increasingly important role. Data protection products typically have a plurality of concurrent IO threads during operation, and each IO thread first writes data to an intermediate memory and then transmits the data from the intermediate memory to a target memory. A target storage medium refers to a final storage location of data, and may be a non-volatile storage device such as a mechanical hard disk (HDD), a solid state disk (SDD), a magnetic disk array, a remote storage server, or a cloud storage. The intermediate memory typically has a low latency and a high read and write speed relative to the target memory, and may be used as a buffer to store data written by an IO thread and then synchronize the data to the target memory. In addition, there is often a management control flow in a data protection product that periodically writes data in an intermediate memory to a target memory, thereby ensuring the data consistency. In addition, a read/write operation of the control flow has a high priority and need to block all concurrent IO threads.

In the related art, for either a read/write lock or a semaphore mechanism, every IO thread needs to acquire and release locks frequently. This kind of lock operation will introduce an additional overhead, especially in a highly concurrent scenario, frequent lock competition may greatly reduce the system performance. In addition, the inability to acquire a read/write lock often results in an excessively long single congestion time of IO threads, which also affects the efficiency of the data protection product.

Therefore, the embodiments of the present disclosure propose a solution for data synchronization. Firstly, when a state variable of an execution state of a control flow related to data synchronization is in a first state, a timeout period for acquiring a read lock is set for an IO thread. If acquiring the read lock times out, the state variable is set to a second state to indicate that the control flow has timed out, and then the data synchronization is continued by utilizing the IO thread.

Therefore, according to the embodiments of the present disclosure, by managing the state variable, the IO thread attempts to acquire a lock only when the control flow performs data synchronization, thereby significantly reducing the lock usage frequency and synchronization overhead. At the same time, the introduction of a timeout mechanism allows the IO thread to set the state variable after timeout and skip waiting to continue data synchronization, which avoids a long-time congestion of the IO thread, thereby improving the concurrency performance of the system. By combining the two mechanisms, the solution provided in the embodiments of the present disclosure achieves a low-overhead and high-efficiency synchronization operation while ensuring data consistency, which is particularly applicable to a highly concurrent data protection scenario.

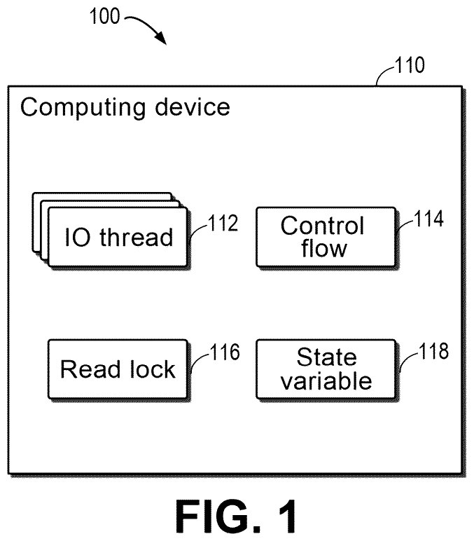

The basic principles and several example implementations of the present disclosure are described below with reference to FIG. 1 to FIG. 6. It should be understood that these example embodiments are given only to enable those skilled in the art to better understand and thus implement the embodiments of the present disclosure, and are not intended to limit the scope of the present disclosure in any way.

FIG. 1 shows an example environment 100 in which a device and/or a method according to an embodiment of the present disclosure can be implemented. As shown in FIG. 1, the example environment 100 may include a computing device 110, which may be a user terminal, a mobile device, a computer, or the like, and may also be a computing system, a single server, a distributed server, or a cloud-based server. The computing device 110 may be deployed in a data protection system or can also be deployed in a cloud and connected with a data protection system via a network, and embodiments of the present disclosure do not limit this.

In a data protection product, an IO thread may write data from an external application to an intermediate memory (such as a PMEM or a DRAM) and transmit the data from the intermediate memory to a target memory at an appropriate time. A main task of a control flow is to periodically check the data in the intermediate memory and synchronize it to the target memory to ensure the consistency of the data. The computing device 110 may set, in response to a state variable 118 being in a first state, a timeout period for an IO thread 112 to acquire a read lock 116, the state variable 118 being used for indicating an execution state of a control flow 114 associated with data synchronization, and the first state indicating that the control flow 114 is executing the data synchronization. In some embodiments, the IO thread 112 may include a plurality of threads, and may operate in a concurrent manner, with each thread processing a data transmission task from an external application. The IO thread 112 is capable of completing writing of data to the intermediate memory and transmitting the data from the intermediate memory to the target memory in a highly concurrent environment.

If the IO thread 112 does not acquire the read lock 116 within the timeout period, the computing device 110 may set the state variable 118 to a second state, the second state indicating that the control flow 114 has timed out. For example, if an IO thread 112 cannot successfully acquire a read lock 116 within a set timeout period while the control flow 114 is performing a data synchronization operation and occupying the intermediate memory, to avoid the IO thread from impacting the overall performance due to a long-time congestion, the computing device 110 may identify that the operation of the control flow 114 has timed out by changing the state variable 118 from the first state to the second state.

After the state variable 118 is set to the second state, the computing device may continue to perform the data synchronization by utilizing the IO thread 112. It should be noted that the data synchronization operations of the IO thread 112 and the control flow 114 have different objectives. The IO thread 112 is primarily responsible for storing data generated by an external application in the intermediate memory and transmitting the data from the intermediate memory to the target memory to ensure persistent storage of and subsequent accesses to the data. The data synchronization operation of the IO thread 112 refers to the transmitting its externally written data (also known as first target data) from the intermediate memory to the target memory. The operation of the IO thread has a high frequency, a plurality of threads may run concurrently, and each thread completes its assigned task independently, so as to support a highly concurrent data processing environment.

On the other hand, the data synchronization operation of the control flow 114 refers to periodically checking the data in the intermediate memory and synchronizing the data (also referred to as second target data) to the target memory to ensure that the data in the target memory is consistent with the data in the intermediate memory. Thus, the operation of the control flow 114 is global and focuses on the overall consistency of the storage system rather than on a single data transmission task.

It should be understood that the architecture and functions in the example environment 100 are described only for illustrative purposes, without implying any limitation on the scope of the present disclosure. The embodiments of the present disclosure may also be applied to other environments having different structures and/or functions.

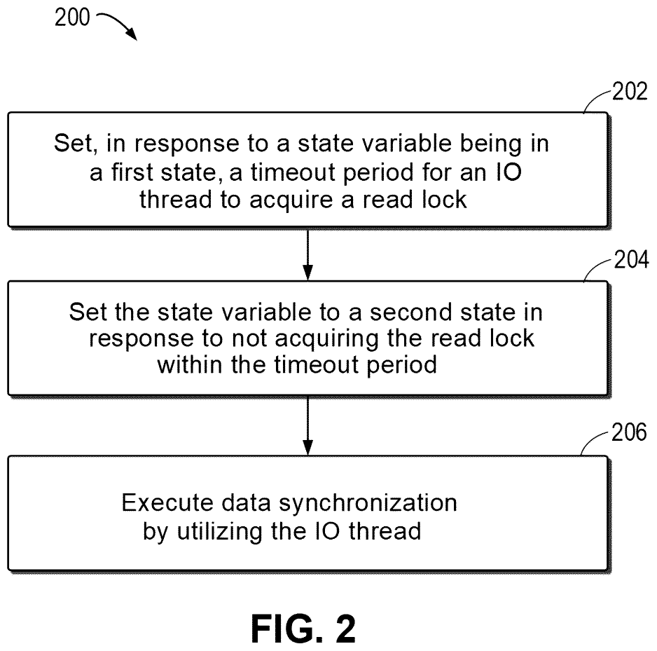

A process according to the embodiments of the present disclosure will be described in detail below with reference to FIG. 2 to FIG. 6. For ease of understanding, specific data mentioned in the following description are all examples and are not intended to limit the scope of protection of the present disclosure. It should be understood that the embodiments described below may also include additional actions not shown and/or may omit actions shown, and the scope of the present disclosure is not limited in this regard.

FIG. 2 is a flow chart of a method 200 for data synchronization according to an embodiment of the present disclosure. At a block 202, a timeout period for an IO thread to acquire a read lock may be set in response to a state variable being in a first state, the state variable being used for indicating an execution state of a control flow associated with data synchronization, and the first state indicating that the control flow is executing the data synchronization. For example, as described with reference to FIG. 1, the computing device 110 may set, in response to the state variable 118 being in the first state, the timeout period for the IO thread 112 to acquire the read lock 116, the state variable 118 being used for indicating the execution state of the control flow 114, and the first state indicating that the control flow 114 is executing the data synchronization.

At a block 204, the state variable is set to a second state in response to not acquiring the read lock within the timeout period, the second state indicating that the control flow has timed out. For example, as described with reference to FIG. 1, in response to not acquiring the read lock 116 within the timeout period, the computing device 110 may set the state variable 118 to a second state, the second state indicating that the control flow 114 has timed out. At a block 206, the data synchronization may be executed by utilizing the IO thread. For example, as described with reference to FIG. 1, the computing device 110 may perform the data synchronization by utilizing the IO thread 112.

Therefore, in the method 200 according to the embodiments of the present disclosure, by managing the state variable, all the IO threads can attempt to acquire locks only when the control flow performs read/write operations, and this design greatly reduces the lock usage frequency. In most cases, an IO thread can directly perform the data transmission operation, thereby greatly reducing the synchronization overhead. Moreover, the timeout mechanism is introduced, and a timeout period is set when an IO thread attempts to acquire a lock. If the timeout occurs, the IO thread sets the state variable to skip waiting and directly continue the data synchronization, and the operation of the control flow will be marked as failed. Such design avoids a long-time congestion of the IO thread, thereby improving the system performance. By combining the two mechanisms, the solution achieves a low-overhead and high-efficiency synchronization operation while ensuring the data consistency.

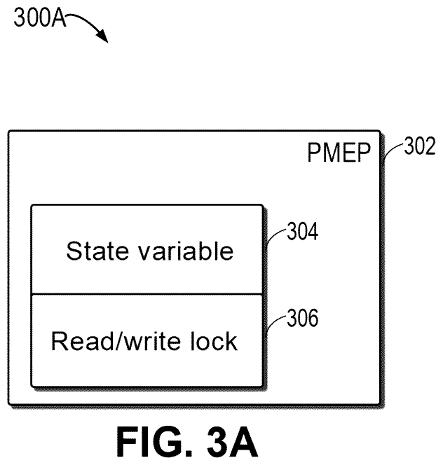

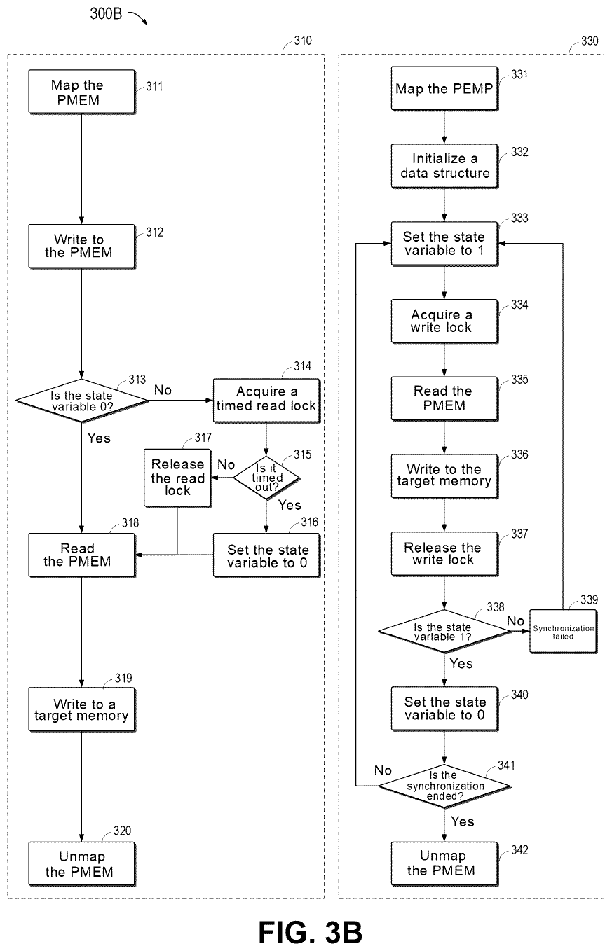

FIG. 3A is a schematic diagram of a data structure 300A according to an embodiment of the present disclosure. As shown in FIG. 3A, a state variable 304 and a read/write lock 306 may be set in a Persistent Memory (PMEM) 302. The PMEM 302 is a non-volatile memory with both memory and storage characteristics, and compared with a DRAM, it has a characteristic of data persistent storage after power failure. The PMEM 302 may be mapped directly to an address space of a process, thereby reducing the latency of storage access. By reserving a fixed region in the PMEM 302 for storing data structures required for synchronization (for example, the state variable 304 and the read/write lock 306), data access and state update may be quickly implemented in a highly concurrent scenario, thereby improving the system performance. It should be understood that using the PMEM is only an implementation of the memory, the embodiments of the present disclosure are not limited to the PMEM, and other types of memories may also be available.

Because a PMEM library allows an application to map a PMEM into an address space of a process and provides a characteristic of byte addressability, the application can perform reading and writing to the PMEM as to the DRAM. In addition, the PMEM can always be mapped to the same address space when used, in contrast to the case where a normal memory may be mapped to a different space each time when used as a shared memory. Therefore, no additional handle management is required to use the PMEM, thereby simplifying the programming process and significantly improving the convenience of failure recovery. Even if the control flow crashes unexpectedly and needs to be recovered, only remapping of the PMEM is required to complete a recovery operation without any impact on the normal operation of the IO thread.

The state variable 304 is an atomic variable that supports an atomic operation and is used for indicating information related to the execution state of the control flow. In some embodiment, the state variable 304 may record three states of the control flow using only one bit, including that no read/write operation is in progress (NO_PROCESS), a read/write operation is in progress (IN_PROCESS), and a read/write operation times out (TIMEOUT). For example, when the value of the state variable is 0, it indicates that the control flow is in the NO_PROCESS state, at which time the control flow is not performing any read/write operation. When the value of the state variable is 1, it indicates that the control flow is in the IN_PROCESS state, that is, the control flow is performing a read/write operation, and at this point, the IO thread needs to acquire a read lock to ensure data consistency. In addition, with the timeout mechanism, the TIMEOUT state may be represented when the value of the state variable changes from 1 to 0 (triggered by the IO thread after it detects timeout). At this point, although the physical value of the state variable is 0, in combination with the timeout-triggered logic, it may be clear that this is a state switch due to timeout, not a normal NO_PROCESS state. It should be understood that the present disclosure does not limit the number of bits used by the state variable, and more bits may be used to represent the three states of the control flow.

The read/write lock 306 is a lock mechanism for inter-thread synchronization that allows a plurality of threads to read shared resources at the same time, but allows only one thread to write resources. In the embodiments of the present disclosure, the read/write lock 306 may be implemented by a read/write lock provided by a standard library, or by a customized lock mechanism. The read/write lock 306 functions to ensure that the control flow can monopolize resources during a read/write operation, thereby avoiding competitive accesses to the persistent memory by other threads. For IO threads, only when the control flow does not occupy resources can they perform operations by acquiring read locks, thus achieving mutual exclusion and synchronization between threads. By setting the state variable 304 and the read/write lock 306 in the PMEM 302, the embodiments of the present disclosure can provide an efficient synchronization mechanism in a highly concurrent environment, thereby effectively reducing the system overhead due to lock competition and state update, and ensuring the consistency and reliability in the data synchronization process.

FIG. 3B is a schematic diagram of a data synchronization process 300B according to an embodiment of the present disclosure. As shown in FIG. 3, a dashed frame 310 describes an execution process of an IO thread, and a dashed frame 330 describes an execution process of a control flow. In a data protection product, an IO thread may write data from an external application to an intermediate memory (such as a PMEM or a DRAM) and transmit the data from the intermediate memory to a target memory at an appropriate time. A main task of the control flow is to periodically check the data in the intermediate memory and synchronize it to the target memory to ensure the consistency of the data.

At a block 311, the PMEM may be mapped. For example, during the data synchronization, mapping the PMEM may establish a mapping relationship between a physical storage space and a virtual address space, allowing applications to access data in the PMEM directly in a byte-addressing manner. By mapping the PMEM, the data in the PMEM may be supplied to the IO thread. In some embodiments, the mapping operation may be accomplished via a dedicated library supported by the PMEM or a memory mapping function provided by an operating system. At a block 312, data may be written to the PMEM. For example, in a data protection product, after the IO thread receives data from an external application, it may write the data directly to the PMEM. As a high-performance non-volatile storage medium, the PMEM has a lower access latency and a higher read and write speed than conventional storage devices. Therefore, using the PMEM as an intermediate memory not only can improve the efficiency of data write, but also can provide a cache support for subsequent synchronization operations. In addition, due to the data persistence of the PMEM, the written data can be completely retained even in the case of power-down or failure of the system, thereby enhancing the reliability of the system.

At a block 313, it may be determined whether the state variable is 0. With reference to FIG. 3A, that state variable is the state variable 304 shown in FIG. 3A. As described above, the state variable may occupy only one bit to record the three states of the control flow, including that a read/write operation is in progress (also referred to as a first state), a read/write operation times out (also referred to as a second state), and no read/write operation is in progress (also referred to as a third state). If the state variable is not 0, it indicates that the state variable is in the first state, and the procedure proceeds to a block 314.

At the block 314, a timed read lock may be acquired. For example, when the state variable indicates that the control flow is performing a read/write operation (first state), the IO thread needs to synchronize with the control flow by acquiring the timed read lock. An acquisition mechanism of the timed read lock allows the IO thread to attempt to acquire the lock within a limited waiting time. At a block 315, it may be determined whether the read lock can be successfully acquired within a predetermined timeout period. If the read lock cannot be successfully acquired within the predetermined timeout period, it indicates that the control flow may not be able to complete the operation in a timely manner for some reason. At this point, the IO thread no longer continues to wait, and the procedure proceeds to a block 316, in which the state variable may be set to the second state (timeout state) by converting the bit in the state variable from 1 to 0, and it continues to perform subsequent synchronization tasks. Such design can avoid long-time congestion of the IO thread, and ensure the system's response speed and processing efficiency in a highly concurrent scenario.

The operation of acquiring the read lock ensures that the IO thread will not make conflicting modifications or accesses to data in the persistent memory during the operation of the control flow. If the read lock is successfully acquired within the predetermined timeout period, it indicates that the control flow has completed its operation, and the procedure proceeds to a block 317 in which the read lock may be released. After the read lock is successfully acquired and it is confirmed that the operation of the control flow is completed, the protection function of the read lock is completed, and releasing the read lock at this point may allow other IO threads to access the data in the PMEM, thereby avoiding long-term occupation of resources. After the read lock is released, the IO thread is able to continue the subsequent data synchronization task, that is, reading target data from the PMEM and writing it to the target memory.

Return to the block 313, if the state variable is 0, it indicates that the state variable is in the third state, indicating that no read/write operation is currently performed by the control flow, that is, no synchronization operation is performed. In the third state, the control flow is in an idle state, so that the IO thread can directly perform a read/write operation of the data without waiting or synchronizing with the control flow. Then, the procedure proceeds to a block 318 where the IO thread reads the target data from the PMEM and writes it to the target memory at a block 319. The read/write operations of the control flow are periodic and relatively few, and therefore, the proportion of time when the state variable is in the third state is high. Therefore, the embodiments of the present disclosure enable the IO thread to run efficiently without control flow intervention in most cases, thereby reducing the lock competition and synchronization overhead, and improving the overall performance of the system in highly concurrent scenarios. At a block 320, the PMEM may be unmapped. For example, after the data synchronization process is completed, the operation of unmapping the PMEM may release the mapping relationship between the PMEM and the virtual address space.

The process of executing data synchronization by the control flow may continue to be described below with reference to FIG. 3B. At a block 331, the PMEM may be mapped, which is similar to the mapping of the PMEM described in the step 311. At a block 332, a data structure may be initialized. For example, after the control flow is started, the data structure in the PMEM, that is, the state variable 304 and the read/write lock 306 shown in FIG. 3A, needs to be initialized first. The initial value of the state variable 304 is typically set to 0 (NO_PROCESS state) to indicate that the current control flow has not performed any read/write operation. At the same time, the read/write lock 306 is also initialized to a state that is not occupied by any thread, so that subsequent threads can normally acquire the lock for synchronization operations.

At a block 333, the state variable may be set to 1. For example, before the control flow is about to perform a read/write operation, the value of the state variable 304 needs to be changed from 0 (NO_PROCESS state) to 1 (IN_PROCESS state) through an atomic operation, thus indicating that the state of the control flow is switched from idle to performing a read/write operation, and all IO threads are informed that the current control flow is occupying resources. The operation of setting the state variable to 1 is performed atomically to ensure consistency and integrity of state updates in a multi-threaded environment.

After the state variable is set to 1, the control flow enters the subsequent data synchronization process. At a block 334, a write lock may be acquired. At this point, the control flow takes an exclusive right to access the PMEM by acquiring a write lock in the read/write lock 306. Due to the characteristic of the write lock, all IO threads attempting to access the PMEM may be blocked until the control flow completes its operation and releases the write lock. At a block 335, the PMEM may be read. The control flow, after successfully acquiring the write lock, reads the target data from the PMEM that needs to be synchronized to the target memory. At a block 336, the data may be written to the target memory. The control flow writes the data read from the PMEM to the target memory (such as a hard disk or cloud storage), for implementing persistent storage. The target memory is usually used as a final storage location of the data, and the write operation ensures long-term storage of the data and reliability of the system. At a block 337, the write lock may be released. After the control flow completes the data synchronization operation, the right to access the PMEM is returned to other IO threads by releasing the write lock.

At a block 338, it may be determined whether the state variable is still 1. After the control flow completes its read/write operation and releases the write lock, the control flow needs to check the value of the state variable to confirm whether the data synchronization operation is successful. If the value of the state variable has been set by the IO thread to 0 (that is, the timeout state), it indicates that during the operation performed by the control flow, the IO thread is unable to acquire the read lock due to the timeout mechanism, chooses to skip waiting, and directly performs a subsequent operation (that is, it is determined to be timed out at the block 315). In this case, the procedure proceeds to a block 339, the control flow needs to mark this operation as failed because the timeout may cause the operations of the control flow and the IO thread to fail to be effectively synchronized, and the procedure returns to the block 333 to perform the data synchronization again. If the value of the state variable is still 1 (that is, the state of the control flow is still IN_PROCESS), it indicates that the timeout does not occur, the synchronization operation of the control flow has been completed successfully, and the control flow can enter a subsequent process.

At a block 340, the state variable may be set to 0. After the control flow successfully completes the data synchronization operation, the state variable is set from 1 (IN_PROCESS state) to 0 (NO_PROCESS state), indicating that the operation of the control flow has ended. This operation is completed atomically to ensure the integrity and consistency of state updates in a multi-threaded environment.

Setting the state variable to 0 may inform all IO threads that the current control flow has released the occupation of the PMEM and that IO threads may read and write normally. At a block 341, it may be determined whether the data synchronization of the control flow is completed (for example, whether synchronization of all data is completed); if not, the procedure returns to the block 333 to continue to execute the data synchronization, and if yes, the procedure proceeds to a block 342 to unmap the PMEM.

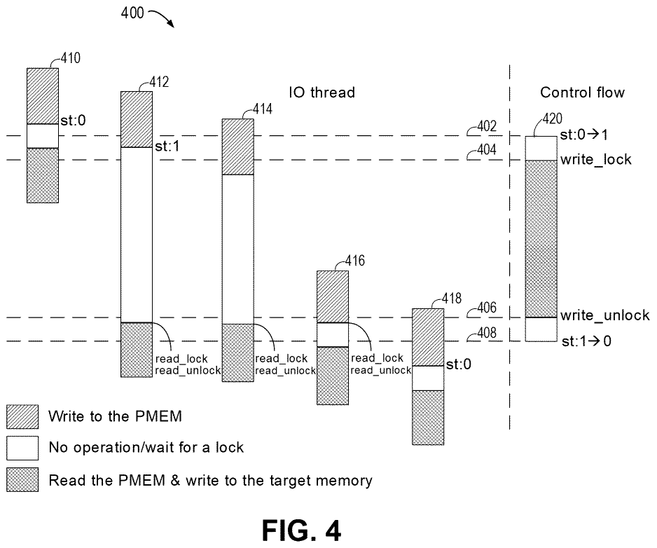

FIG. 4 is a schematic diagram of a scenario 400 of data synchronization according to an embodiment of the present disclosure. As shown in FIG. 4, the figure shows an execution process of a plurality of IO threads and one control flow, showing an interaction mechanism between the IO threads and the control flow and its impact on data synchronization under different state variable (st) values. In FIG. 4, a dotted line 402 and a dotted line 404 represent a change in the value of the state variable st, and since the scenario does not involve control flow timeout, the state variable may be switched between two states: st=0 (NO_PROCESS), which indicates that the control flow is not performing an operation, and st=1 (IN_PROCESS), which indicates that the control flow is performing a read/write operation. Different shadow areas in FIG. 4 represent different operations, including writing to the PMEM, no operation/waiting for a lock, and reading the PMEM and writing to the target memory.

Referring to an IO thread 410, an IO thread 414, and an IO thread 416, when the PMEM write operation is completed before the state of a control flow 420 changes, the data written to the target memory will be up-to-date, and therefore, the IO thread does not need to acquire a read lock. Referring to an IO thread 412, when the PMEM write operation of the IO thread ends and the state variable has been set to 1, it indicates that the control flow 420 has started its operation. In this case, the IO thread 412 needs to wait to acquire the read lock. There may be an overlap between the PMEM write operation of the IO thread 412 and the read/write operations of the control flow 420, resulting in a temporary inconsistency between data in the target memory and data in the PMEM; however, the subsequent read/write operation of the IO thread 412 will ensure that the data in the target memory is up-to-date. Referring to an IO thread 418, once the operation of the control flow 420 is completed, the state variable is reset to 0, and subsequent IO threads will not be affected.

In general, when the control flow begins to operate, the state variable changes from 0 to 1, preventing newly written data from conflicting with the operation of the control flow. When the control flow completes the operation and resets the state variable to 0, operations of subsequent IO threads are not affected. Subsequent operations can still ensure data consistency even when the operations of the control flow and the IO thread may overlap.

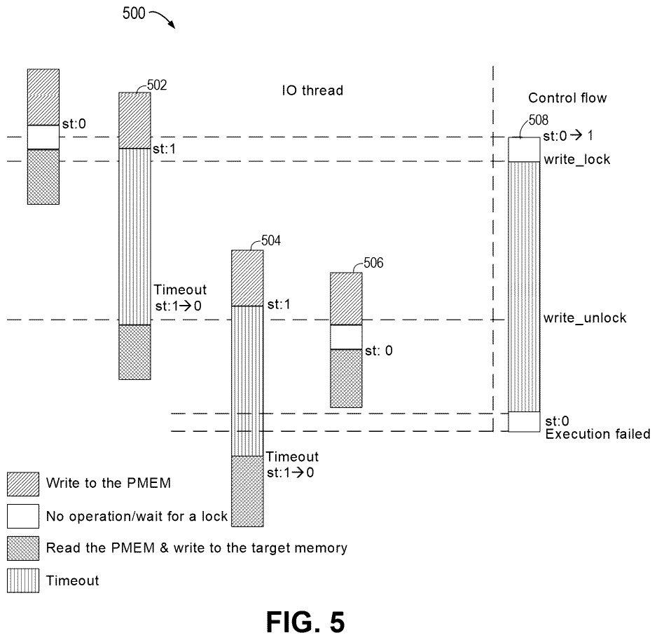

FIG. 5 is a schematic diagram of another scenario 500 of data synchronization according to an embodiment of the present disclosure. FIG. 5 shows an interaction mechanism between the control flow and a plurality of IO threads and its impact on data synchronization in the event of control flow timeout. In this scenario, the control flow 508 fails to complete the operation within a predetermined time, resulting in being determined as timeout, which then triggers state update and operation adjustment associated with the IO thread. When the control flow 508 is started (the state variable changes from st=0 to st=1), a write lock is acquired and a read/write operation is performed. When the control flow is occupying resources, all IO threads in a waiting state need to obtain a read lock to continue operating.

As shown in FIG. 5, when the control flow 508 fails to complete the operation due to timeout (the time for the state variable remaining 1 exceeds a predetermined time limit), the IO thread waiting for the read lock will also trigger a corresponding processing logic due to the timeout mechanism. Referring to an IO thread 502, the timed-out IO thread sets the state variable to 0 and continues its read/write operation to avoid being congested for a long time. In addition, referring to a thread 504, after the IO thread sets the state variable to 0 due to timeout, subsequent IO threads will no longer be affected by the operation of the control flow 508. Therefore, the data synchronization solution proposed by the embodiments of the present disclosure can always guarantee the data consistency between the PMEM and the target memory under any circumstances.

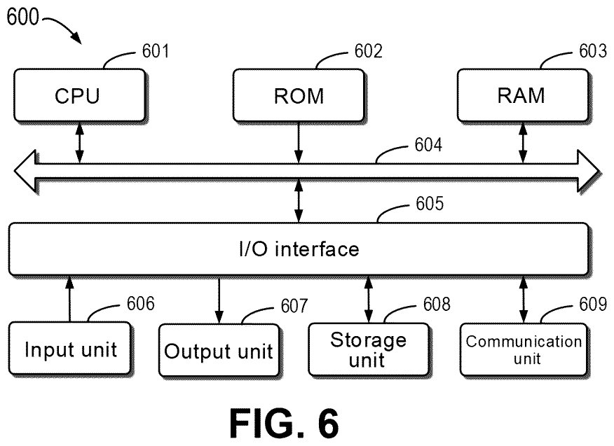

FIG. 6 is a schematic block diagram of a device 600 that may be configured to implement an embodiment of the present disclosure. The device 600 may be a device or an apparatus as described in the embodiments of the present disclosure. As shown in FIG. 6, the device 600 includes a central processing unit (CPU) 601 that may perform various appropriate actions and processing according to computer program instructions stored in a read-only memory (ROM) 602 or computer program instructions loaded from a storage unit 608 to a random access memory (RAM) 603. Various programs and data required for the operation of the device 600 may also be stored in the RAM 603. The CPU 601, the ROM 602, and the RAM 603 are connected to each other through a bus 604. An input/output (I/O) interface 605 is also connected

A plurality of components in the device 600 are connected to the I/O interface 605, including: an input unit 606, such as a keyboard or a mouse; an output unit 607, such as various types of displays or speakers; the storage unit 608, such as a magnetic disk or an optical disc; and a communication unit 609, such as a network card, a modem, or a wireless communication transceiver. The communication unit 609 allows the device 600 to exchange information/data with other devices via a computer network, such as the Internet, and/or various telecommunication networks.

The various methods or processes described above may be performed by the processing unit 601. For example, in some embodiments, the methods may be implemented as a computer software program that is tangibly included in a machine-readable medium such as the storage unit 608. In some embodiments, part of or all the computer program can be loaded and/or installed onto the device 600 via the ROM 602 and/or the communication unit 609. When the computer program is loaded onto the RAM 603 and executed by the CPU 601, one or more steps or actions of the methods or processes described above may be performed.

In some embodiments, the methods and processes described above may be implemented as a computer program product. The computer program product may include a computer-readable storage medium on which computer-readable program instructions for performing various aspects of the present disclosure are loaded.

The computer-readable storage medium may be a tangible device that can retain and store instructions for use by an instruction execution device. For example, the computer-readable storage medium may be, but is not limited to, an electrical storage device, a magnetic storage device, an optical storage device, an electromagnetic storage device, a semiconductor storage device, or any suitable combination of the above. More specific examples (a non-exhaustive list) of the computer-readable storage medium include: a portable computer disk, a hard disk, a random access memory (RAM), a read-only memory (ROM), an erasable programmable read-only memory (EPROM or a flash memory), a static random access memory (SRAM), a portable compact disc read-only memory (CD-ROM), a digital versatile disc (DVD), a memory stick, a floppy disk, a mechanical encoding device such as a punch card or protrusions in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices, or downloaded to an external computer or external storage device via a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

The computer program instructions for performing the operations of the present disclosure may be assembly instructions, instruction set architecture (ISA) instructions, machine instructions, machine-related instructions, microcode, firmware instructions, status setting data, or source code or object code written in any combination of one or more programming languages, including object-oriented programming languages as well as conventional procedural programming languages. The computer-readable program instructions may be executed entirely on a user's computer, partly on a user's computer, as a stand-alone software package, partly on a user's computer and partly on a remote computer, or entirely on a remote computer or a server. In a case where a remote computer is involved, the remote computer can be connected to a user computer through any kind of networks, including a local area network (LAN) or a wide area network (WAN), or can be connected to an external computer (for example, connected through the Internet using an Internet service provider). In some embodiments, an electronic circuit, for example, a programmable logic circuit, a field-programmable gate array (FPGA), or a programmable logic array (PLA), is customized by utilizing state information of the computer-readable program instructions. The electronic circuit may execute the computer-readable program instructions so as to implement various aspects of the present disclosure.

These computer-readable program instructions can be provided to a processing unit of a general-purpose computer, a special-purpose computer, or another programmable data processing apparatus to produce a machine, such that these instructions, when executed by the processing unit of the computer or another programmable data processing apparatus, generate an apparatus for implementing the functions/actions specified in one or more blocks in the flow charts and/or block diagrams. The computer-readable program instructions may also be stored in a computer-readable storage medium. These instructions cause a computer, a programmable data processing apparatus, and/or another device to operate in a particular manner, such that the computer-readable medium storing the instructions includes an article of manufacture which includes instructions for implementing various aspects of the functions/actions specified in one or more blocks in the flow charts and/or block diagrams.

The computer-readable program instructions can be loaded onto a computer, other programmable data processing apparatuses, or other devices, so that a series of operating steps are performed on the computer, other programmable data processing apparatuses, or other devices to produce a computer-implemented process. Therefore, the instructions executed on the computer, other programmable data processing apparatuses, or other devices implement the functions/actions specified in one or more blocks in the flow charts and/or block diagrams.

The flow charts and block diagrams in the accompanying drawings show the architectures, functionalities, and operations of possible implementations of the device, the method, and the computer program product according to a plurality of embodiments of the present disclosure. In this regard, each block in the flow charts or block diagrams may represent a module, a program segment, or part of instructions, which contains one or more executable instructions for implementing specified logical functions. In some alternative implementations, the functions noted in the blocks may also occur in an order different from that noted in the accompanying drawings. For example, two consecutive blocks may in fact be executed substantially concurrently, and sometimes they may also be executed in the reverse order, depending on the functions involved. It should also be noted that each block in the block diagrams and/or flow charts and combinations of blocks in the block diagrams and/or flow charts can be implemented with a dedicated hardware-based system that performs specified functions or actions, or with a combination of dedicated hardware and computer instructions.

Various embodiments of the present disclosure have been described above. The foregoing description is illustrative rather than exhaustive, and is not limited to the disclosed embodiments. Multiple modifications and variations will be apparent to those skilled in the art without departing from the scope and spirit of the illustrated various embodiments. The selection of terms as used herein is intended to best explain the principles and practical applications of the various embodiments or the technical improvements to technologies on the market, or to enable other persons of ordinary skill in the art to understand the embodiments disclosed here.

1. A method for data synchronization, comprising:
setting, in response to a state variable being in a first state, a timeout period for an input/output (IO) thread to acquire a read lock, the state variable being used for indicating an execution state of a control flow associated with data synchronization, and the first state indicating that the control flow is executing the data synchronization;
setting the state variable to a second state in response to not acquiring the read lock within the timeout period, the second state indicating that the control flow has timed out; and
executing the data synchronization by utilizing the IO thread.

2. The method according to claim 1, wherein executing the data synchronization by utilizing the IO thread comprises:
reading first target data to be synchronized from an intermediate memory by the IO thread, wherein the first target data is written to the intermediate memory by the IO thread, and the intermediate memory is used for buffering data written by the IO thread; and
writing the first target data to a target memory, wherein the target memory is used for persisting data from the intermediate memory.

3. The method according to claim 2, wherein the intermediate memory is a persistent memory (PMEM), and the state variable is an atomic variable supporting an atomic operation.

4. The method according to claim 1, wherein setting the timeout period for the IO thread comprises:
determining, in response to the state variable being in the first state, that the IO thread for executing the data synchronization is congested; and
setting, in response to the IO thread being congested, the timeout period for the IO thread.

5. The method according to claim 1, further comprising:
releasing the acquired read lock in response to that the read lock is acquired within the timeout period; and
executing, after the read lock is released, the data synchronization by utilizing the IO thread.

6. The method according to claim 1, further comprising:
determining, in response to the state variable being in a third state, that the control flow is not executing the data synchronization; and
executing the data synchronization by utilizing the IO thread.

7. The method according to claim 1, further comprising:
setting the state variable to the first state in response to initiating the data synchronization executed by the control flow; and
writing, by acquiring a write lock, second target data acquired from an intermediate memory to a target memory, the second target data being at least a portion of data stored on the intermediate memory.

8. The method according to claim 7, further comprising:
determining, in response to the state variable being the second state, that the data synchronization executed by the control flow is failed; and
re-initiating, in response to the data synchronization being failed, the data synchronization executed by the control flow.

9. The method according to claim 7, further comprising:
determining, in response to the state variable being the first state, that the data synchronization executed by the control flow is successful; and
setting the state variable to a third state, wherein the third state indicates that the control flow is not executing the data synchronization.

10. The method according to claim 9, further comprising:
determining whether the data synchronization executed by the control flow is completed; and
continuing, in response to the data synchronization executed by the control flow not being completed, execution of the data synchronization by setting the state variable from the third state to the first state.

11. An electronic device, comprising:
a processor; and
a memory coupled to the processor and having instructions stored therein, wherein the instructions, when executed by the processor, perform following actions:
setting, in response to a state variable being in a first state, a timeout period for an input/output (IO) thread to acquire a read lock, the state variable being used for indicating an execution state of a control flow associated with data synchronization, and the first state indicating that the control flow is executing the data synchronization;
setting the state variable to a second state in response to not acquiring the read lock within the timeout period, the second state indicating that the control flow has timed out; and
executing the data synchronization by utilizing the IO thread.

12. The electronic device according to claim 11, wherein executing the data synchronization by utilizing the IO thread comprises:
reading first target data to be synchronized from an intermediate memory by the IO thread, wherein the first target data is written to the intermediate memory by the IO thread, and the intermediate memory is used for buffering data written by the IO thread; and
writing the first target data to a target memory, wherein the target memory is used for persisting data from the intermediate memory.

13. The electronic device according to claim 12, wherein the intermediate memory is a persistent memory (PMEM), and the state variable is an atomic variable supporting an atomic operation.

14. The electronic device according to claim 11, wherein setting the timeout period for the IO thread comprises:
determining, in response to the state variable being in the first state, that the IO thread for executing the data synchronization is congested; and
setting, in response to the IO thread being congested, the timeout period for the IO thread.

15. The electronic device according to claim 11, wherein the actions further comprise:
releasing the acquired read lock in response to that the read lock is acquired within the timeout period; and
executing, after the read lock is released, the data synchronization by utilizing the IO thread.

16. The electronic device according to claim 11, wherein the actions further comprise: determining, in response to the state variable being in a third state, that the control flow is not executing the data synchronization; and
executing the data synchronization by utilizing the IO thread.

17. The electronic device according to claim 11, wherein the actions further comprise:
setting the state variable to the first state in response to initiating the data synchronization executed by the control flow; and
writing, by acquiring a write lock, second target data acquired from an intermediate memory to a target memory, the second target data being at least a portion of data stored on the intermediate memory.

18. The electronic device according to claim 17, wherein the actions further comprise:
determining, in response to the state variable being the second state, that the data synchronization executed by the control flow is failed; and
re-initiating, in response to the data synchronization being failed, the data synchronization executed by the control flow.

19. The electronic device according to claim 17, wherein the actions further comprise:
determining, in response to the state variable being the first state, that the data synchronization executed by the control flow is successful; and
setting the state variable to a third state, wherein the third state indicates that the control flow is not executing the data synchronization.

20. A computer program product, the computer program product being tangibly stored on a non-volatile computer-readable medium and comprising machine-executable instructions, wherein the machine-executable instructions, when executed by a machine, cause the machine to perform following actions:
setting, in response to a state variable being in a first state, a timeout period for an input/output (IO) thread to acquire a read lock, the state variable being used for indicating an execution state of a control flow associated with data synchronization, and the first state indicating that the control flow is executing the data synchronization;
setting the state variable to a second state in response to not acquiring the read lock within the timeout period, the second state indicating that the control flow has timed out; and
executing the data synchronization by utilizing the IO thread.
